(19) United States
(12) Patent Application Publication
(10) Pub. No.: US 2007/0168248 A1
(43) Pub. Date: Jul. 19, 2007

(54) Sales promotion device

(75) Inventors: Wilhelmus Franciscus Johannes Fontijn, Eindhoven (NL); Declan Patrick Kelly, Shanghai (CN); Franciscus Lucas Antonius Johannes Kamperman, Eindhoven (NL); Steven Broeils Luitjens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,324

(22) PCT Filed: Nov. 22, 2004
(86) PCT No.: PCT/IB04/52503

§ 371 Date: Jun. 9, 2006

(30) Foreign Application Priority Data
Dec. 11, 2003 (EP) 03104637.8

(51) Int. Cl. G06Q 30/00; G06Q 20/00

(52) U.S. Cl. 705/14; 705/21

(57) ABSTRACT

There is provided a sales promotion device (10) for modifying purchasing behavior. The device (10) is distinguished in that it includes spatially co-located first and second component parts (20, 30; 40, 50, 60). The first component part (20, 30) comprises a consumer product (20) and the second component part (40, 50, 60) is operable to encourage a purchaser of the device (10) to seek one or more further products (30), the second part (40, 50, 60) being electronically responsive when spatially presented by the purchaser at retailing premises (200) to enable the purchaser to gain access to and/or take possession of the one or more further products (30).

The present invention relates to sales promotion devices, for example sales promotion devices provided with consumer products for modifying purchasing behavior to encourage seeking of additional products. Moreover, the present invention also relates to methods of using such sales promotion devices to modify purchasing behavior.

Sales promotion devices and methods are well known and include free gifts, postal mail-shots and public advertisements, for example on television and in newspapers. Moreover, the methods include sales approaches and/or visits made by sales personnel to potential customers. Whereas advertisements are often imprecisely targeted to potential future customers, for example as in television and/or general newspaper advertising, and therefore costly on account of their relative ineffectiveness, approaches made by sales personnel is costly in human time and therefore often unsuitable for promoting relatively low-cost more specialist items for potential sale to diverse customer groups.

The inventors have therefore appreciated that there is a requirement for more targeted sales promotion, for example to assist with sale of relatively lower-cost items to diverse customers groups, without there being a need for considerable human intervention and therefore associated high sales costs.

Sales promotion devices are already known. For example, in a published United States patent application no. US 2001/0038033, there is described a miniature CD ROM or other physical sales media such as RFID identifiers susceptible for use in distributing client software to users; here, RFID is an abbreviation for “radio frequency identification device”. Such client distribution media also comprises additional software, such as that used to encrypt a document, create a virtual private network, videoconference and the like. Moreover, such media is susceptible to being used in the context of credit cards, telephone calling cards, debit cards, employee identification cards, access control cards and for other purposes. Associated with such sales media is a server operable to function as a central point through which communication services, such as data transmission, telephony, video conferencing and the like are accessible. Moreover, the server is configurable to store user profile information such as user preferences, user contact information, user calendar information and other such information. Furthermore, the server is also useable to create rule-based commerce accounts accessible through client distribution media or through methods associated with conventional commerce accounts such as bank accounts.

The inventors have appreciated that, although it is known to add RFID components to products, these components are not always used to best advantage. In particular, the inventors have appreciated that such RFID components are capable of being used to boost future potential sales, provided that they are employed in an appropriate targeted manner, for example according to the present invention.

A first object of the present invention is to provide a sales promotion device capable of modifying purchasers' behavioral patterns to encourage additional sales.

A second object of the invention is to a provide a method of using a sales promotion device for modifying purchasers' behavioral patterns to encourage additional sales.

A third object of the invention is to provide a sales system in which offers of items susceptible to purchase are more effectively targeted at potential purchasers.

According to a first aspect of the present invention, there is provided a sales promotion device for modifying purchasing behavior, characterized in that the device includes spatially co-located first and second component parts, said first component part comprising a consumer product and said second component part being operable to encourage a purchaser of the device to seek one or more further products, said second part being electronically responsive when spatially presented by the purchaser at retailing premises to enable the purchaser to gain access to and/or take possession of said one or more further products.

The invention is of advantage in that it is capable of addressing at least one of the objects of the invention for promoting sales.

It will be appreciated that the expression “retailing premises” is to be construed broadly to include not only shops, supermarkets, department stores but also other venues such as theatres, concert halls, transport vehicles such as buses, trans, aircraft, ships and aircraft, the invention having an aim to encourage customers to return to such venues.

Preferably, the device is arranged in operation to cause the purchaser to be exposed to a range of other purchasing opportunities when said device is spatially presented in proximity of said retailing premises for purposes of gaining access to and/or taking possession of said one or more further products. Such exposure is susceptible to promoting further sales by drawing the purchaser's attention to related products without there being a need for intervention of staff employed at the retailing premises.

Preferably, in the device, said one or more further products are included in the first component part in initially substantially inaccessible form at an instance when the purchaser purchases the device, said one or more further products subsequently being rendered accessible when the purchaser presents said device at said retailing premises. Such inaccessibility is of advantage in that the purchaser is obliged to return to the retailing premises in order to gain access as a reward to said one or more further products. For example, a user will often already own a replaying apparatus, for example a CD-ROM player, and will purchase a data carrier such as a CD-ROM, namely the CD-ROM corresponding to the “device”. Presentation of the device, namely the CD-ROM, at the retailing premises will enable access to other data material dormant on the CD-ROM.

Preferably, the device is arranged so that initial access at said retailing premises for providing subsequent access by the purchaser to said one or more further products is limited to at least one time interval. Imposition of such a time interval is capable of imparting greater urgency to the purchaser thereby potentially expediting the purchaser's return to the retailing premises.

Preferably, in the device, the second component includes a communication transponder for use in communicating at said retailing premises to enable the purchaser to gain access to and/or take possession of said one or more further products. Use of the transponder is of advantage in that the purchaser is potentially unaware of interaction occurring between the second part and the purchasing premises, thereby potentially circumventing any reluctance on the part of the purchaser to return to the retailing premises because of technical complexity of the device and its associated modes of operation.

Preferably, in the device, said transponder includes at least one of an optical transponder, a radio transponder, an acoustic transponder and an electrically-connectable contact transponder. Whereas the electrically-connectable contact transponder is potentially least expensive to implement, the use of a radio transponder, for example a proprietary Blue Tooth radio transponder, is of benefit in that it is potentially most user-trasparent in operation. The transponder is preferably a radio frequency identification tag (RFID).

Preferably, in the device, the second component part includes a data field for use in identifying to said retailing premises an identification for said second component part. Inclusion of the data field for use in identifying said second component part is of benefit in that it is susceptible to being used to target further sales materials, for example one or more targeted advertisements, to the purchaser.

Preferably, in the device, said second component part includes a data field for storing access indicative data indicative of whether or not said one or more further products have been made available to the purchaser. More preferably, the data field is one or more memory locations in non-volatile electronic memory, although other alternative implementations are possible such as optical markings.

Preferably, in the device, the first component part is a data carrier bearing the consumer product in readily accessible software form. More preferably, the first component part is an optically readable data carrier such as a compact disc (CD), for example including a software game, a feature film and/or an electronic manuscript such as an atlas ROM.

Preferably, in the device, the first and second component parts are a substantially unitary item. Such substantially unitary implementation is of potential benefit in that the purchaser is obliged to relate the first component part to said one or more further products, thereby reinforcing a desirable association in the mind of the purchaser.

Preferably, the device is implemented such that the first component part is a compact disc susceptible to optical interrogation, and the second part is a radio transponder device incorporated as a part of the disc and substantially unitary therewith.

According to a second aspect of the invention, there is provided a method of operating a sales promotion device for modifying purchasing behavior, characterized in that the method includes the steps of:
(a) arranging for the device to include spatially co-located first and second component parts, said first component part comprising a consumer product;
(b) arranging for said second part to encourage a purchaser of the device to seek one or more further products; and
(c) arranging for said second part to be electronically responsive when spatially presented by the purchaser at retailing premises to enable the purchaser to gain access and/or take possession of said one or more further products.

Preferably, the method further comprises a step of arranging for the device in operation to cause the purchaser to be exposed to a range of other purchasing opportunities when said device is spatially presented in proximity of said retailing premises for purposes of gaining access and/or taking possession of said one or more further products.

Preferably, the method further comprises a step of arranging for said one or more further products to be included in the first component part in initially substantially inaccessible form at an instance when the purchaser purchases the device, said one or more further products subsequently being rendered accessible when the purchaser presents said device at said retailing premises.

Preferably, the method further comprises a step of arranging for the device to limit access by the purchaser so that initial access at said retailing premises for providing subsequent access by the purchaser to said one or more further products is limited to at least one time interval.

Preferably, the method further includes a step of arranging for the second component to include a communication transponder for use in communicating at said retailing premises to enable the purchaser to gain access to and/or take possession of said one or more further products.

Preferably, the method further comprises a step of arranging for said transponder to include at least one of an optical transponder, a radio transponder, an acoustic transponder and an electrically-connectable contact transponder.

Preferably, the method further comprises a step of including a data field in the second component part for use in identifying to said retailing premises an identification for said second component part.

Preferably, the method further comprises a step of arranging for said second component part to include a data field for storing access indicative data indicative of whether or not said one or more further products have been made available to the purchaser.

Preferably, the method is implemented such that the first component part is a data carrier bearing the consumer product in readily accessible form.

Preferably, the method further comprises a step of arranging for the first and second component parts to be a substantially unitary item.

Preferably, the method is implemented such that the first component part is a compact disc susceptible to optical interrogation, and the second part is a radio transponder device incorporated as a part of the disc and substantially unitary therewith.

According to a third aspect of the present invention, there is provided a sales promotion system characterized in that it comprises at least one sales promotion device for modifying purchasing behavior and retailing premises including communicating means for communicating with said at least one device when presented in spatial proximity therewith, said at least one device including spatially co-located first and second component parts, said first component part comprising a consumer product and said second component part being operable to encourage a purchaser of the at least one device to seek one or more further products, said second part being electronically responsive when spatially presented by the purchaser to said communicating means at retailing premises to enable the purchaser to gain access and/or take possession of said one or more further products.

It will be appreciated that features of the invention are susceptible to being combined in any combination without departing from the scope of the invention.

Embodiments of the invention will now be described, by way of example only, with reference to the following diagrams wherein:

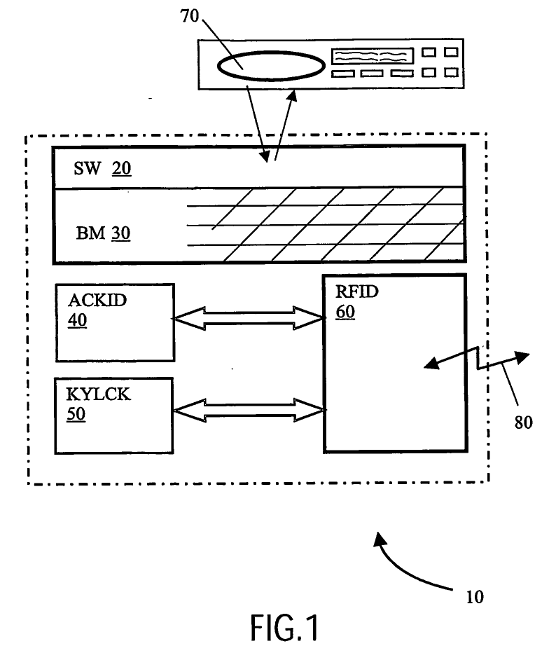

FIG. 1 is a schematic diagram of a compact disc (CD) with associated radio frequency identity device (RFID) integrated therewith; and

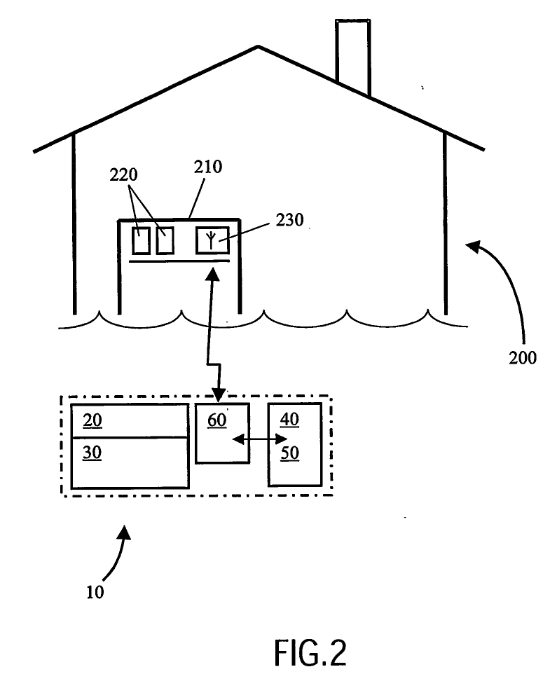

FIG. 2 is a schematic diagram of retailing premises including a department including a transponder compatible with the compact disc of FIG. 1.

The present invention is concerned with a sales promotion device, retailing facilities for interfacing to the promotion device and methods of using the promotion device. The promotion device in combination with the retailing facilities thereby comprise a system for the promotion of sales.

The promotion device will firstly be described with reference to FIG. 1.

The promotion device is indicated generally by 10 and resembles superficially in appearance a conventional compact disc, also known colloquially as a “CD”, or a proprietary “Portable Blue” (PB) type of 3 to 5 cm diameter optical disc data carrier developed by a company Philips N. V. based in Holland, or another digital storage carrier. The CD 10, or alternatively PB optical disc, comprises a data carrying optically-readable metallic layer bearing immediately-accessible software (SW) 20 together with bonus software material (BM) 30. The bonus software material 30 is encoded in encrypted form and only accessible to a user after authorization which will be described in greater detail later. The CD 10 further comprises a radio frequency identification device (RFID) 60 together with associated data fields including an acknowledgement identification (ACKID) 40 and an asset key-lock (KYLCK) 50 preferably coupled to the RFID 60; the RFID 60 is preferably implemented as a RFID tag. The acknowledgement identification 40 and the key-lock 50 are beneficially implemented as one or more digital bits in non-volatile memory associated with the RFID 60 although other implementations are feasible. The CD 10 includes a conventional optical protection layer, for example fabricated from substantially optically-trnsparent polycarbonate plastics material, so that an optical CD reader 70 is capable of interrogating the software 20 and the bonus material 30 through the protection layer. Similarly, the RFID 60 is susceptible to communicating from the CD 10 by way of bi-directional radio radiation at a radiation carrier frequency in the order of 1 GHz, for example at radio frequencies associated with proprietary contemporary Blue-Tooth RFID tags.

As an alternative implementation of the CD 10, the acknowledgement identification 40 and/or the asset key-lock 50 are susceptible to being implemented as optically-readable data fields susceptible to being modified optically, for example laser modifiable in a manner akin to optically writable CD's. Preferably, the RFID 60 is included as an integral part of the CD 10 to provide the RFID 60 with physical protection as well as preventing removal and/or tampering. More preferably, the optically-readable metallic layer bearing the software 20 is also functional as a patch antenna for the RFID 60 by arranging for electrical connection therebetween.

The aforementioned retailing facilities will now be described with reference to FIG. 2.

In FIG. 2, there is shown retailing facilities indicated generally by 200. The facilities 200 are susceptible to comprising retailing outlets such as a shop, a store, a supermarket or similar. In the retailing facilities 200, there is included a department 210 comprising one or more merchandise presentation shelves. On the shelves are products 220 which a proprietor of the retailing facilities 200 would like to entice a possessor of the CD 10 to purchase. The department 210 also includes a transponder device 230 operable to communicate with the CD 10 and its associated RFID 60. If required, the transponder device 230 is coupled to a database (not shown), for example by way of the Internet and/or a telephone network.

Operation of the CD 10 in combination with the retailing facilities 200 will now be described with reference to FIGS. 1 and 2.

A user travels to the retailing facilities 200 and visits the department 210 where the user is enticed to purchase the CD 10. On initial purchase of the CD 10, the user is only allowed access to the software 20 by way of the acknowledgement ID 40 and the key-lock 50 being set to values corresponding to locked status of the bonus material 30. Subsequently, the user departs from the retailing facilities 200 and, for example at home, inserts the CD into the user's CD player. Where the CD player is an older model of conventional optical CD player, the user is able to access the immediately-accessible software 20; the bonus material 30 is substantially inaccessible in such conventional older conventional players. Conversely, where the CD player is provided with RFID interrogating facilities for interrogating the RFID 60, the player is operable to access the key-lock 50 and determine its logic status.

When the key-lock 50 is set to a value “0”, namely its initial value on initial sale of the CD 10 to the user, the CD player interprets this value to communicate to the user that the bonus material 30 is not presently available and that the user is advised to seek the material 30 from a place where the CD 10 was originally purchased. Conversely, when the key-lock 50 has been subsequently set to a value “1”, the CD player interprets this value to communicate that the bonus material is available and is susceptible to being accessed if so desired. The user himself/herself is not capable of identifying how to set the key-lock 50 unless, for example, the user is an experienced computer hacker. Changing the value of the key-lock 50 will next be described with reference to FIG. 2.

Where the CD 10 is a music CD, the software 20 includes one or more sound tracks including a sound track portion providing an audio advertisement enticing the user to return to the retailing premises 200 to receive as a reward one or more free bonus sound tracks, for example by seeking out the transponder device 230. Alternatively, where the CD 10 is a software CD, for example a games software CD, the software 20 includes a software track operable on execution to present to the user an audio and/or visual advertisement enticing the user to return to the retailing premises 200 to receive as a reward free bonus games software, for example an upgrade or extension of the software 20 readily accessible on the CD 10. The advertisement in particular encourages the user to seek out the transponder device 230.

In receiving the aforesaid advertisement enticing the user, the user returns to the retailing premises 200 to search Such a search by the user is potentially of advantage in that it does not involve significant supervision time, if any, from personnel employed in the premises 200. In locating the device 230, the user's attention is drawn to the other products 220 and the user is potentially enticed to purchase one or more of them by becoming aware of them. Such enticement is a desired outcome of use of the present invention.

When the user locates the transponder device 230 and is in relatively close proximity thereto, the RFID 60 is operable to communicate with the transponder device 230, the device 230 being capable of interrogating the CD 10 to verify its authenticity by virtue of the acknowledgement identification 40 being communicated to the device 230 via the RFID 60. If required, the acknowledgement identification 40 is susceptible to being in encrypted form for verification by the device 230 in connection with a database by way of private-public key encryption. Where the CD 10 is found to be authentic, the device 230 is operable to modify the key-lock 50 from a logic “0” value to a logic “1” value, thereby enabling the user to gain access to the bonus material 30. The user then returns with the CD to play it in an appropriate CD drive capable of interrogating the identification 40 via the RFID 60 and thereby gain access not only to the software 20 but also now to the bonus material 30.

Optionally, access to the bonus material 30 is susceptible to being time-limited, for example in a manner of a time-limited offer active in an offer period between an earlier start date and a later stop date. Such time-limit control is susceptible to being determined either by the device 230, or by the device 230 operating in combination with a central database (not shown). Preferably, the device 230 in combination with its database is operable to accumulate data regarding purchasing habits and/or preferences of the user so that promotional literature and other approaches can be made to the user regarding other relates types of product which are likely to be of interest to the user, for example by way of mail shots, personalized e-mail messages and the like.

In the event that a hacker is able to identify that the key-lock 50 allows access to the bonus material 30, the hacker will merely be accessing additional data and/or software which was intended to be free bonus material. Moreover, on account of the relative ease with which the user is capable of obtaining access to the bonus material 30, namely by-visiting the premises 200 and searching in the department 210 to find the device 230, there is relatively little incentive for a hacker to try to distribute the bonus material 30 in pirated form to a great extent, for example via networks such as the Internet, as it is relatively difficult for such a hacker to obtain information of users who have purchased examples of the CD 10 and thereby target them.

By virtue of the RFID 60 and its associated identification 40 and key-lock 50, together with mutually compatible communication hardware in the form of the transponder device 230, it is feasible to modify purchasing behavior of the user for drawing the user's attention to products which are likely to be of interest. Moreover, the modification of behavior occurs without taking valuable time from staff employed at the premises 200.

If required, the bonus software 30 is susceptible to being used as an inducement to purchase yet further software, namely the bonus software 30 is capable of being configured to entice the user to seek further products. Such further enticement is to be regarded as various “layers' of enticement, each “layer” preferably having associated therewith an associated key-lock 50 in the CD 10 and optionally time limited at the device 230. Thus, the user is repetitively enticed to return to the premises 200 and thereby be exposed to new advertising material when seeking the transponder device 230. More preferably, the “layers” are staggered in time to cause the user to return at regular intervals to the premises 200 seeking each time different bonus products.

Although embodiments of the invention are described in the foregoing in respect of CD's bearing software, it will be appreciated that the present invention is susceptible to other classes of products. For example, the RFID 60 can be attached to clothing which is sold with promotional material operable to inform the user that returning to the premises 200 to seek the transponder device 230 will result in bonus products, for example a free accessory item of clothing such as a scarf. In searching out the device 230 in the premises 200, the user is exposed to other potential offers of related products which potentially tempt the user to make additional purchases to the benefit of the proprietor of the premises 200. Again, the user is tempted towards targeted products without the proprietor needing to expend considerable personnel time, such personnel time being potentially financially costly to the proprietor. The RFID 60 is susceptible to being provided with its own miniature display, for example a liquid crystal device (LCD) and/or an e-ink display including reversible electrically-alterable ink, for presenting visual information of inducements to the user.

The invention is of benefit in that it is capable of providing more targeted product promotion and thereby reducing costs of conventional advertising which is often financially inefficient, for example as in newspaper and/or television advertising.

It will be appreciated that embodiments of the invention described in the foregoing are susceptible to being modified without departing from the scope of the invention.

The acknowledgement identification (ACKID) 40 is beneficially stored on the CD 10, or alternatively on the aforementioned proprietary Portable Blue (PB) optical disc, in its associated Sapphire Keylocker. “Sapphire” is a proprietary digital storage standard for optical data storage media, for example for optical discs, being adopted by Philips N. V. of Holland in collaboration with Sony of Japan. A “keylocker” is defined as a structure within Sapphire for storing securely keys and rights on disc. The transponder device 230 is then preferably a Sapphire compatible device. Moreover, a RFID tag is preferably attached to a shelf or service counter in the retailing facilities 200, for example in relatively close proximity to a subsequent product of the same manufacturer as the CD or PB disc 10. In an event that the identification 40 matches the RFID 60, the subsequent product is released as a free bonus. Such an arrangement within the retailing facilities 200 is especially advantageous as a proprietor of the retailing facilities 200 does not need to become actively involved when customers seek out their free bonus subsequent product.

In describing and claiming the present invention, it will be appreciated that expressions such as “include”, “comprise”, “incorporate”, “contain”, “have” and “is” are to be construed as being non-exclusive, namely allowing for presence of other items or components which are not explicitly disclosed.

1. A sales promotion device (10) for modifying purchasing behavior, including spatially co-located first component part (20, 30) and second component part (40, 50, 60), said first component part (20, 30) comprising a consumer product and said second component part (40, 50, 60) being operable to encourage a purchaser of the device (10) to seek one or more further products (220), said second part (40, 50, 60) being electronically responsive when spatially presented by the purchaser at retailing premises (200) to enable the purchaser to gain access to and/or take possession of said one or more further products (220).

2. A device (10) according to claim 1, wherein the device (10) is arranged in operation to cause the purchaser to be exposed to a range of other purchasing opportunities (220) when said device (10) is spatially presented in proximity of said retailing premises (200, 230) for purposes of gaining access to and/or taking possession of said one or more further products (220).

3. A device (10) according to claim 1, wherein said one or more further products (30) are included in the first component part in initially substantially inaccessible form at an instance when the purchaser purchases the device (10), said one or more further products subsequently being rendered accessible when the purchaser presents said device (10) at said retailing premises (200).

4. A device (10) according to claim 1, wherein the device (10) is arranged so that initial access at said retailing premises (200) for providing subsequent access by the purchaser to said one or more further products is limited to at least one time interval.

5. A device (10) according to claim 1, wherein the second component part (40, 50,60) includes a communication transponder (60) for use in communicating at said retailing premises (200, 230) to enable the purchaser to gain access and/or take possession of said one or more further products (220; 30).

6. A device (10) according to claim 5, wherein said transponder (60) includes at least one of an optical transponder, a radio transponder, an acoustic transponder and an electrically-connectable contact transponder.

7. A device (10) according to claim 1, wherein the second component part (40, 50, 60) includes a data field (40) for use in identifying to said retailing premises (200) an identification for said second component part (40, 50, 60).

8. A device (10) according to claim 7, wherein said second component part (40, 50, 60) includes a data field (50) for storing access indicative data indicative of whether or not said one or more further products (220, 30) have been made available to the purchaser.

9. A device (10) according to claim 1, wherein the first component part (20, 30) is a data carrier bearing (20) the consumer product in readily accessible software form.

10. A device (10) according to claim 1, wherein the first and second component parts are a substantially unitary item.

11. A device (10) according to claim 1, wherein the first component part (20, 30) is a compact disc susceptible to optical interrogation, and the second part is a radio transponder device incorporated as a part of the disc and substantially unitary therewith.

12. A method of operating a sales promotion device (10) for modifying purchasing behavior, including the steps of:
(a) arranging for the device (10) to include spatially co-located first and second component parts (20, 30, 40, 50, 60), said first component part (20, 30) comprising a consumer product (20);
(b) arranging for said second part (40, 50, 60) to encourage a purchaser of the device (10) to seek one or more further products (220, 30); and
(c) arranging for said second part (40, 50, 60) to be electronically responsive when spatially presented by the purchaser at retailing premises (200) to enable the purchaser to gain access to and/or take possession of said one or more further products (230, 30).

13. A method according to claim 12, further comprising a step of arranging for the device (10) in operation to cause the purchaser to be exposed to a range of other purchasing opportunities (230) when said device is spatially presented in proximity of said retailing premises (200) for purposes of gaining access to and/or taking possession of said one or more further products (230, 30).

14. A method according to claim 12, further comprising a step of arranging for said one or more further products to be included in the first component part (30) in initially substantially inaccessible form at an instance when the purchaser purchases the device (10), said one or more further products (30) subsequently being rendered accessible when the purchaser presents said device (10) at said retailing premises (200).

15. A method according to claim 12, further comprising a step of arranging for the device (10) to limit access by the purchaser so that initial access at said retailing premises (200) for providing subsequent access by the purchaser to said one or more further products (30) is limited to at least one time interval.

16. A method according to claim 12, further including a step of arranging for the second component (40, 50, 60) to include a communication transponder (60) for use in communicating at said retailing premises (200, 230) to enable the purchaser to gain access and/or take possession of said one or more further products (230, 30).

17. A method according to claim 16, further comprising a step of arranging for said transponder (60) to include at least one of an optical transponder, a radio transponder, an acoustic transponder and an electrically-connectable contact transponder.

18. A method according to claims 12, further comprising a step of including a data field in the second component part for use in identifying to said retailing premises an identification for said second component part.

19. A method according to claim 18, further comprising a step of arranging for said second component part to include a data field for storing access indicative data indicative of whether or not said one or more further products have been made available to the purchaser.

20. A method according to claims 12, wherein the first component part is a data carrier bearing the consumer product in readily accessible form.

21. A method according to claims 12, further comprising a step of arranging for the first and second component parts to be a substantially unitary item.

22. A method according to claim 12, wherein the first component part is a compact disc susceptible to optical interrogation, and the second part is a radio transponder device incorporated as a part of the disc and substantially unitary therewith.

23. A sales promotion system (10, 230) comprising at least one sales promotion device (10) for modifying purchasing behavior and retailing premises (200) including communicating means (230) for communicating with said at least one device (10) when presented in spatial proximity therewith, said at least one device (10) including spatially co-located first (20, 30) and second (40, 50, 60) component parts, said first component part (20, 30) comprising a consumer product and said second component part (40, 50, 60) being operable to encourage a purchaser of said at least one device (10) to seek one or more further products (230, 30), said second part (60) being electronically responsive when spatially presented by the purchaser to said communicating means (230) at retailing premises (200) to, enable the purchaser to gain access and/or take possession of said one or more further products (230, 30).
